(19) United States
(12) Patent Application Publication
(10) Pub. No.: US 2006/0170487 A1
(43) Pub. Date: Aug. 3, 2006

(54) A VOLTAGE REFERENCE CIRCUIT FOR ULTRA-THIN OXIDE TECHNOLOGY AND LOW VOLTAGE APPLICATIONS

(75) Inventors: Wagdi W. Abadeer, Jericho, VT (US); John A. Fifield, Underhill, VT (US)

Correspondence Address: IBM MICROELECTRONICS;INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 10/906,012

(22) Filed: Jan. 31, 2005

(51) Int. Cl. G05F 1/10

(52) U.S. Cl. 327/538

(57) ABSTRACT

A precision voltage reference for ultra-thin gate oxide process technologies is realized with a network of tunneling current circuit elements. A voltage difference is measured between selected nodes of one or more current paths of a voltage divider. The tunneling current circuit element may be implemented with any suitable device, such as a parallel plate capacitor or MOSFET. The physical properties of gate tunneling currents enable the voltage reference output to be largely independent of temperature. The circuit may be implemented for low voltage operations with input power supply values of 1.2 volts or less. The output voltage tolerance may be designed to be about ±25% or less of a power supply voltage tolerance. In addition, variations in gate oxide thickness account for a change of less than about ±2% in the voltage reference generator output.

### FIELD OF THE INVENTION

The field of the invention is related to a precision voltage reference for integrated circuits and in particular to a precision voltage reference circuit utilizing a gate tunneling current in semiconductor process technologies employing ultra-thin gate oxides.

### BACKGROUND OF THE INVENTION

A reference voltage generator circuit is useful in a variety of memory and analog circuit applications, including DRAM, flash memory and clock generation schemes. In general, the output of a voltage reference generator must be stable over a range of process, voltage and temperature conditions. It is also beneficial to fabricate the voltage reference generator without incurring additional processing steps during manufacture. In this regard, the bandgap reference voltage generator has been successful in achieving operational stability over a range of environmental and process parameters without adding undue manufacturing complexity. However, continued scaling of integrated circuit physical geometries and commensurate scaling of operating voltages has resulted in reduced effectiveness of bandgap based voltage reference generators.

With current integrated circuit power supplies operating at 1.2 volts and lower, the output and temperature stability of diode and BJT bandgap circuits is limited because the standard to which bandgap reference circuits are designed is 1.22 volts (Silicon bandgap voltage). For reliable operation, a supply voltage must be about 400 mV higher than the target bandgap reference voltage. As such, the standard bandgap voltage of 1.22 volts cannot be maintained. Voltage reference generators with scaled bandgap voltages are known, but require complex initialization circuitry to ensure a single stable operating point for the voltage reference generator output.

Accordingly, a need exists for a voltage reference generator capable of operating at low voltage while producing a stable output over a range of environmental and process parameters.

### SUMMARY OF THE INVENTION

An aspect of the invention is a voltage reference generator utilizing a tunneling current of a MOSFET with an ultra-thin gate oxide to realize a voltage difference that serves as a reference voltage in low voltage applications. A network of MOSFETs is configured such that a voltage difference is measured between selected nodes of a first parallel branch and between selected nodes of a second parallel branch. A third difference is obtained between the first and second branches to obtain a voltage reference. With this arrangement, the supply voltage to the circuit can be as small as desired, enabling a commensurately small voltage reference output. Because of the characteristics of the MOSFET tunneling current, the voltage reference output is independent of temperature within a tolerance of approximately ±0.5% over a temperature range of about −55° C. to 125° C. The output voltage tolerance may be designed to be about

±25% or less of the power supply voltage tolerance. In addition, variations in gate oxide thickness account for a change of less than about ±2% in the voltage reference generator output.

### BRIEF DESCRIPTION OF THE DRAWINGS

FIG. 1 shows a schematic diagram of a parallel plate capacitor network voltage divider.

FIG. 2 illustrates a profile view of a MOSFET device with a tunneling region adjacent to a gate oxide.

FIG. 3 shows a plan view of a physical layout of a serpentine gate structure.

FIG. 4 illustrates a profile view of the serpentine gate structure corresponding to FIG. 3.

FIG. 5 illustrates a plot of NFET gate current as function of oxide thickness.

FIG. 6 depicts a plot of temperature dependency versus gate current.

FIG. 7 shows a plot of the slope parameter AN1 as a function of Vg.

FIG. 8 shows the exponential relationship between the intercept parameter AN2 and Vg.

FIG. 9 illustrates a schematic of a voltage reference circuit according to a first embodiment of the invention.

FIG. 10 depicts a plot of a reference voltage ΔV versus an area ratio, A4/A3, according to the first embodiment.

FIG. 11 shows a plot of the ratio of the lower percent tolerance of ΔV to that of Vdd versus an area ratio, A4/A3, according to the first embodiment.

FIG. 12 illustrates a plot of the ratio of the upper percent tolerance of ΔV to that of Vdd versus an area ratio, A4/A3, according to the first embodiment.

FIG. 13 shows a plot of the percent change in ΔV due to a −7% Change in Tox versus an area ratio, A4/A3, according to the first embodiment.

FIG. 14 illustrates a plot of the percent change in ΔV due to a +7% change in Tox versus an area ratio, A4/A3, according to the first embodiment.

FIG. 15 illustrates a schematic of a voltage reference circuit according to a second embodiment of the invention.

FIG. 16 depicts a plot of a reference voltage ΔV versus area ratios, A4/A3, according to the second embodiment.

FIG. 17 shows a plot of the ratio of a lower percent tolerance of ΔV to that of Vdd versus the area ratio, A4/A3, according to the second embodiment.

FIG. 18 illustrates the ratio of the upper percent tolerance of ΔV to that of Vdd versus area ratio, A4/A3, according to the second embodiment.

FIG. 19 depicts a plot of V1, V2 and ΔV1 versus Vdd for A2/A1=5 and A4/A3=100, according to the first embodiment.

FIG. 20 depicts a plot of V3, V4 and ΔV2 versus Vdd for A2/A1=5, A4/A3=100, according to the first embodiment.

FIG. 21 shows a plot of ΔV versus Vdd for A2/A1=5, A4/A3=100, according to the first embodiment.

FIG. 22 illustrates a plot of the ratio of lower and upper tolerances of ΔV to that of Vdd for A2/A1=5, A4/A3=100, according to the first embodiment.

FIG. 23 illustrates a schematic diagram corresponding to the operational amplifier circuit for the voltage reference according the first embodiment.

### DETAILED DESCRIPTION OF THE PREFERRED EMBODIMENTS

In the following detailed description of embodiments, reference is made to the accompanying drawings which form a part hereof, and in which are shown by way of illustration specific embodiments are described in sufficient detail to enable those skilled in the art to practice the invention, and it to be understood that other embodiments may be utilized and logical, structural, electrical and other changes may be made without departing from the scope of the present invention.

Tunneling current in semiconductor devices is a known phenomena of quantum mechanics that may be exploited using conventional circuit elements to realize a variety of circuit functions. A “tunneling diode” is one example of such a circuit element. Therefore, a detailed explanation of the underlying physics of tunneling currents is not necessary for those skilled in the art to practice the present invention to its broad scope.

In this regard, the term “tunneling current” as used herein and in the appended claims shall include not only tunneling currents in the quantum mechanical sense, but also leakage current that can be present across certain dielectric materials, even without the former being present in a device. This definition of “tunneling current” recognizes that a current having a magnitude on the order of a tunneling current can be achieved without tunneling by, for example, using a “leaky” dielectric layer comprising either an inherently leaky dielectric material, such as tantalum oxide, or an inherently non-leaky material implanted with impurities that render the layer more likely to develop and propagate tunneling currents. Typically, leakage current that flows through a circuit element will be about two orders of magnitude smaller than the current that flows through that element when the element is “conductive,” as this term is defined below. Similarly, the terms “tunneling circuit element” or “tunneling region” and similar terms shall encompass elements capable of propagating a tunneling current or leakage current, or both. In addition, it is also noted that the term “essentially nonconductive” is used herein and in the appended claims relative to an element to indicate that the element conducts a tunneling and/or leakage current across a dielectric layer that does not otherwise permit current to flow. In contrast, the term “conductive” as used herein and in the appended claims relative to such an element indicates that the dielectric layer has been changed, for example, by the formation of a conductive filament, to an extent that current flows through the element primarily by a mode other than tunneling and/or leakage.

Tunneling circuit elements may be implemented using any suitable device, such as a parallel plate capacitor or a metal oxide semiconductor field-effect transistor (MOSFET), among others. However, while tunneling circuit structures may take a variety of forms, much of the description below is directed to the elements implemented with MOSFET devices. Generally, this is due to MOSFET devices being most prevalent and readily fabricated using conventional CMOS processing techniques that are widely used in the IC manufacturing industry today. However, those skilled in the art will understand and recognize how to implement tunneling circuit elements with any suitable non-MOSFET device.

Conductive regions may be made of any suitable conductive material, such as a metallic material or a semiconductor material. When tunneling circuit elements are either parallel plate capacitors or MOSFETs, the tunneling regions will comprise a dielectric layer fabricated, for example, with, silicon dioxide, silicon nitride or other dielectric material.

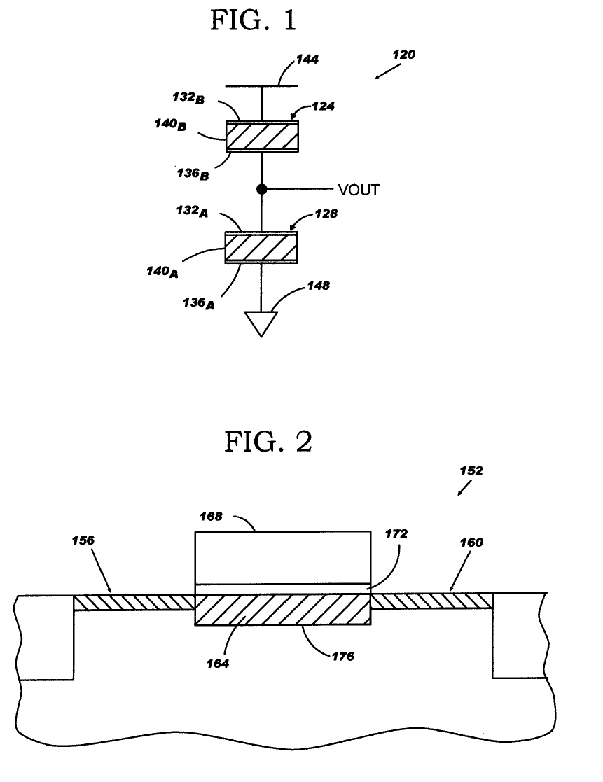

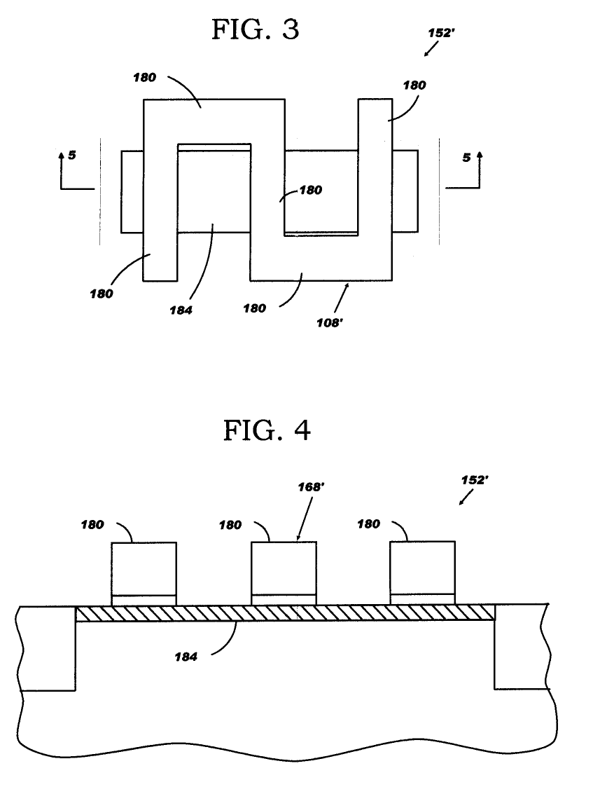

In FIG. 1, a series combination of parallel plate capacitors is configured as a simple voltage divider. In order for a tunneling current to flow through tunneling circuit element 120, tunneling region 140B, 140A will typically be approximately 3.5 nm or less. For example, when tunneling region 140B, 140A is made of silicon dioxide, a dielectric commonly used for gate oxide layer 172 when made using conventional CMOS processing, the thickness of the gate oxide layer will be about 17 Å or less. It has been observed that the tunneling current for one example of tunneling circuit element 128 is about 2.28 nA/(μm2 of oxide layer area) at 1 V when gate oxide layer 172 is a 17 Å thick silicon dioxide layer. Generally, the thinner gate oxide layer 172 is made, the greater the magnitude of the tunneling current. However, thicker dielectric materials may be implanted with impurities to render the dielectric capable of propagating a current within the range of a tunneling current. The area of gate 168 may be made any size needed to suit a particular design. In addition to varying the length and/or width of gate 168, a gate 168′ may include multiple segments 180, such as shown in FIGS. 3 and 4, so as to increase the gate area. In FIGS. 3 and 4, gate 168′ comprises five segments 180, three of which extend over the junction of FET structure 152′.

Referring to FIG. 2, each tunneling circuit element may be made using a conventional FET structure 152 as shown. FET structure 152 may include a source 156, drain 160, channel 164, gate 168 and gate oxide layer 172 made using conventional processing techniques, such as CMOS processing techniques. Variables that affect the tunneling current through oxide layer 172 include the physical thickness of the oxide layer and the physical area of gate 168 in contact with the oxide layer, since, for a given dielectric material for the oxide layer, tunneling current increases (and resistance decreases) with decreasing physical thickness of the oxide layer and increasing area of the gate.

Other variables being equal, tunneling current may also be increased (and resistance decreased) when a tunneling implant region 176 is provided adjacent to oxide layer 172. Tunneling implant region 176 may be implanted with certain dopants that promote tunneling. For example, when MOSFET structure 152 is of the p-type, implant region 176 may be implanted with a high dose of phosphorous atoms. When FET structure 152 is of the n-type, implant region 176 may be implanted with a high dose of boron atoms. Those skilled in the art will appreciate that other dopants may be used.

FIG. 9 shows an exemplary tunneling current voltage divider structure 1 according to a first embodiment. MOSFET devices 10, 20, 30 and 40 correspond to MOSFET Structure 152 in FIG. 2. As discussed above, although the ratio of tunneling currents may be adjusted by changing the gate area of tunneling MOSFET 152, the ratio could alternatively, or additionally, be adjusted by changing other parameters, such as the relative thickness of the oxide layers and the amount of tunneling current enhancing impurities.

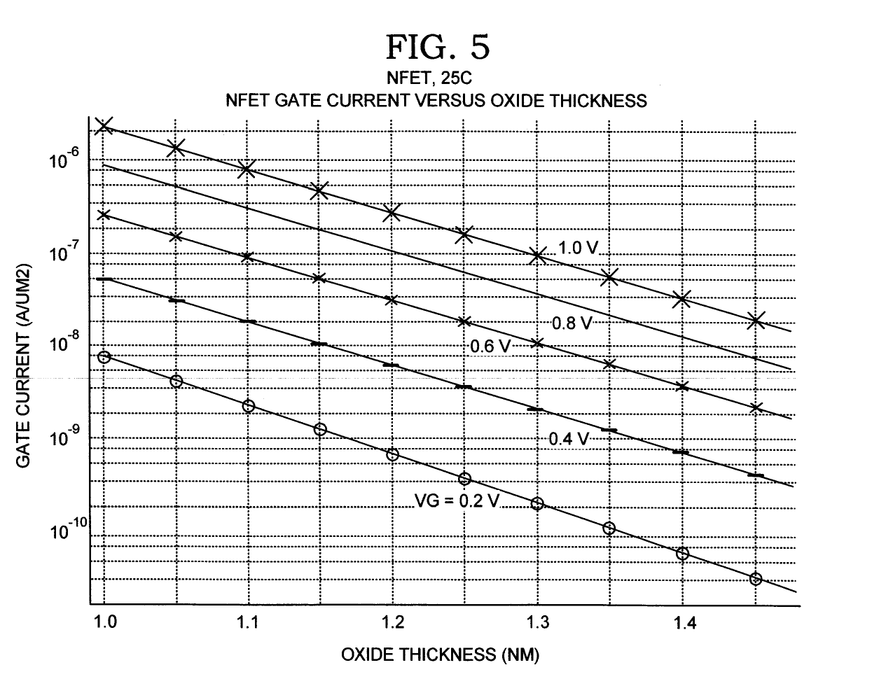

FIG. 5 illustrates gate tunneling current characteristics for an NFET in an exemplar process technology at 25° C., with the gate current expressed in A/μm2. The characteristics are given for gate current as function of oxide thickness with the gate voltage as a parameter. As shown, the gate current on a logarithmic scale is a linear function of the oxide thickness, where the slope and the intercept of the straight line are functions of the gate voltage. In addition to the physical dimension, the oxide thickness in FIG. 5 corresponds to the electrical measurement of a gate current in inversion mode. The correlation of gate current to oxide thickness is achieved through detailed manufacturing analysis of wafer level test results showing the degree of variation in oxide thickness across a wafer.

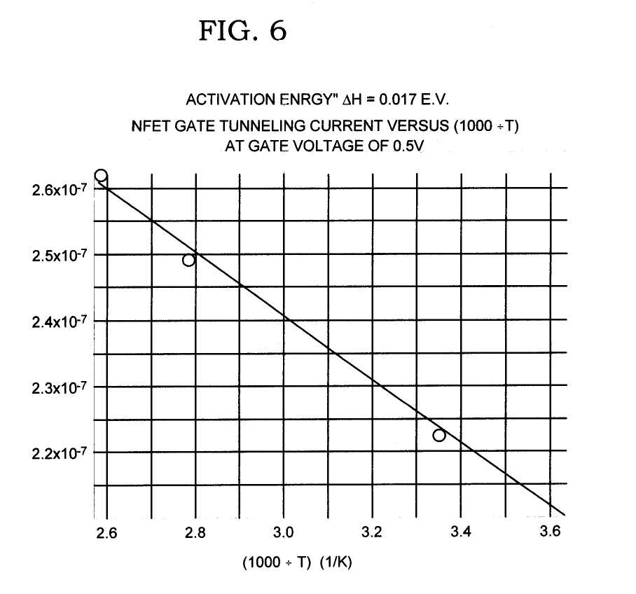

In FIG. 6 a plot of the temperature dependency of the gate tunneling current is shown, with the gate current plotted versus (1000/T), where T is the absolute temperature in units of degrees Kelvin. The range of temperature in FIG. 6 is from 0° C. to 1110° C. (275 to 385° K.). From FIG. 2 the activation energy, ΔH may be derived using equation (4) below, yielding a result of 0.017 eV, which confirms the voltage reference output exhibits limited temperature dependence.

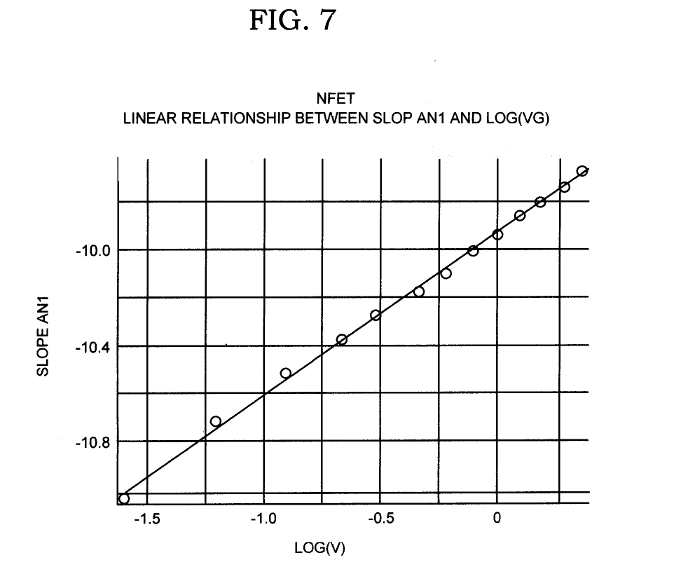

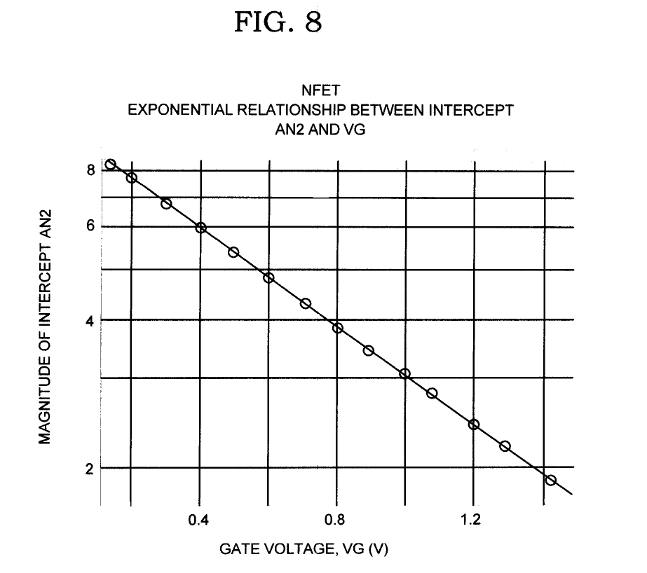

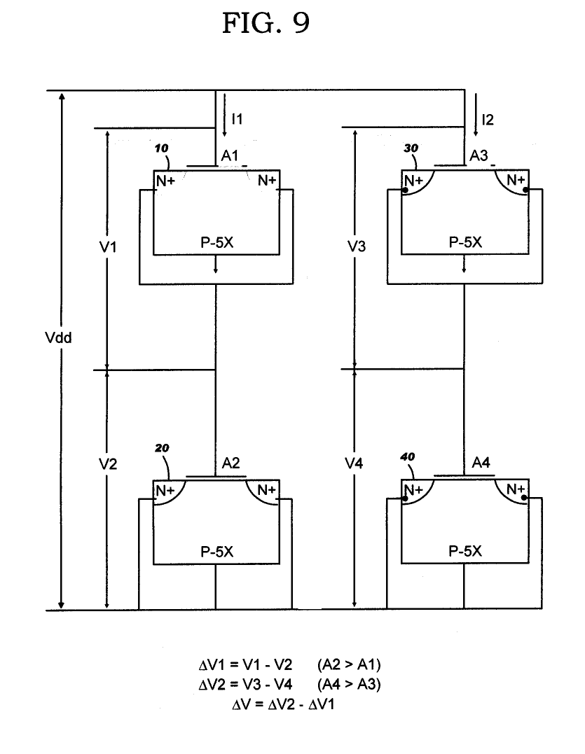

From FIG. 5, the gate tunneling current dependency on oxide thickness can be expressed as:
In(Ig)=AN2+[AN1×Tox] (1)

where the gate current Ig is in A/μm2 and Tox is in nm. AN1 and AN2 are, respectively, the slope and intercept parameters that are functions of gate voltage, Vg. The natural logarithm of gate current has an inverse linear relationship with oxide thickness as expressed in equation (1), corresponding to an increasing gate current with decreasing oxide thickness. The parameter AN1 represents the slope of the straight-line relationship, and the parameter AN2 represents the intercept on the Y-axis, which is the natural log of the gate current. FIG. 7 shows the slope parameter AN1 as a linear function of the natural log of gate voltage while FIG. 8 shows the magnitude of the intercept parameter AN2 on a logarithmic scale as a linear function of the gate voltage.

From the linear relationship between the slope AN1 and the natural log of gate voltage, Vg, AN1 can be expressed as follows:
AN1=[0.673×ln(Vg)]−9.917 (2)

and, referring to FIG. 8, the inverse linear relationship between the log of the magnitude of AN2 and the gate voltage, Vg leads to the following expression for AN2:
AN2=−9.685×exp [−1.159×Vg] (3)

The complete expression of the NFET gate current in A/μm2 as function of temperature, oxide thickness and gate voltage is given as:
In(Ig)=AN2+[AN1×TOX]+{ΔH[(1/T1)−(1/T2)]/K} (4)

where K is Bolztman's constant, AN1 and AN2 are given by equations (2) and (3).

T1 is 298° K. (25° C.), T2 is application temperature in ° K. and ΔH is the activation energy.

A voltage reference circuit 1 according to a first embodiment of the present invention is shown in FIG. 9. The voltage reference circuit according to the first embodiment utilizes a network of four NFET devices configured in two parallel branches. The first branch includes NFETs 10 and 20. The source and drain of NFET 10 form a node that is coupled to the gate of NFET 20, while the source and drain of NFET 20 are coupled to a common potential. The second branch includes NFETs 30 and 40, which are configured similarly to and connected in parallel with NFETs 10 and 20. A current is applied to the gates of NFETS 10 and 30 and a voltage difference is measured between the gates of NFETs and 20 and NFETs 30 and 40, respectively. A final voltage difference is obtained from the previous two measurements to form a reference voltage. The output reference voltage for case 1 is derived as follows:

$$Δ V 1 = V 1 - V 2 ( A 2 > A 1 ) \\ Δ V 2 = V 3 - V 4 ( A 4 > A 3 ) \\ \begin{matrix}Δ V = Δ V 2 - Δ V 1 \\ = V 3 - V 4 - ( V 1 - V 2 ) \\ = Vdd - V 4 - V 4 - ( Vdd - V 2 - V 2 ) \\ = ( 2 \times V 2 ) - ( 2 \times V 4 ) = 2 \times ( V 2 - V 4 )\end{matrix} \qquad ( 5 )$$

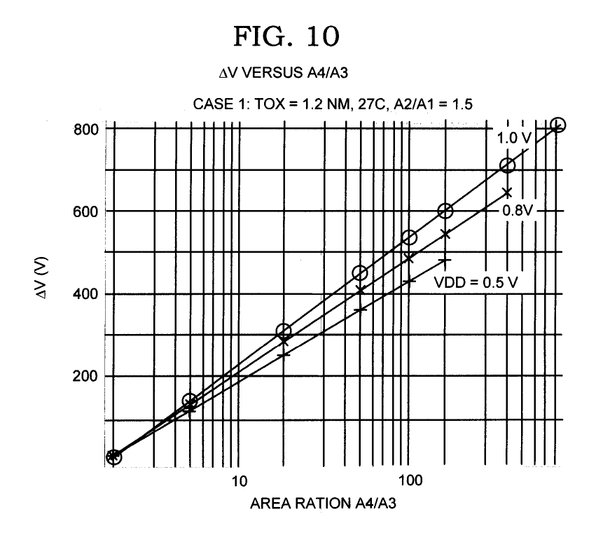

In the accompanying figures, a first design case is presented for a voltage reference generator employing a 1.2 nm oxide thickness with a first gate oxide area ratio, X1=A2/A1=1.5, and a second gate oxide area ratio, X2=A4/A3. The area ratio, X2 is varied over a range of about 2 to 800. The design case according to the first embodiment assumes an operating temperature of about 27° C. In addition, three values for the supply voltage, Vdd, are considered: 0.5 V, 0.8 V, and 1.0 V. FIG. 10 shows the reference voltage ΔV as a function of X2 for the three values of Vdd. From FIG. 10 it can be observed that the reference voltage output varies linearly with area ratio, X2=A4/A3, and therefore any reference voltage value may be generated by proper design of area ratio X2.

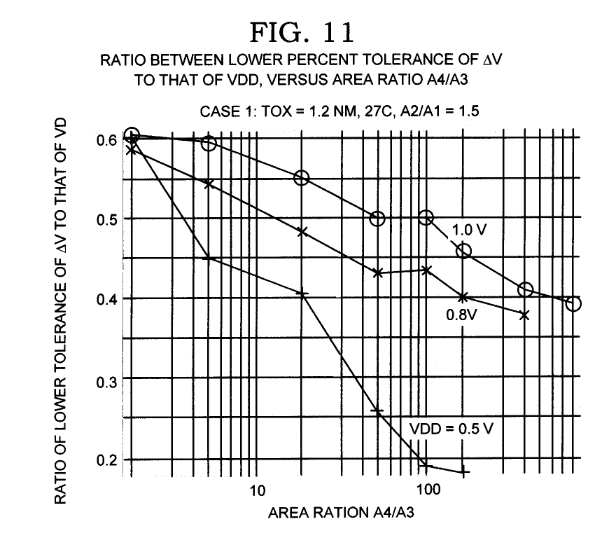

Referring to FIG. 11, the ratio of the lower percent tolerance of ΔV to that of Vdd versus area ratio, X2=A4/A3 is plotted for case 1. ΔV represents the output reference voltage and Vdd is the input power supply of the circuit. Typically, the power supply has an upper and lower tolerance that is, for example, ±10% of Vdd. Conversely, the magnitude of the upper and lower band of the ΔV tolerance range may not be equal due to the highly non-linear I/V characteristics of MOSFET tunneling currents. In FIG. 11, the ratio of the lower percent tolerances of ΔV to that of Vdd versus area ratio, X2 are plotted for Vdd=0.5, 0.8 and 1.0 volts. This ratio is less than one in all cases, which corresponds to a ΔV tolerance less than the Vdd tolerance. In general, the value of area ratio, X2 is inversely proportional to the ratio of lower percent tolerances of ΔV to that of Vdd. As X2 increases, the ratio of lower percent tolerances decreases, and the rate of decrease is higher for lower values of Vdd, which is advantageous in low voltage applications.

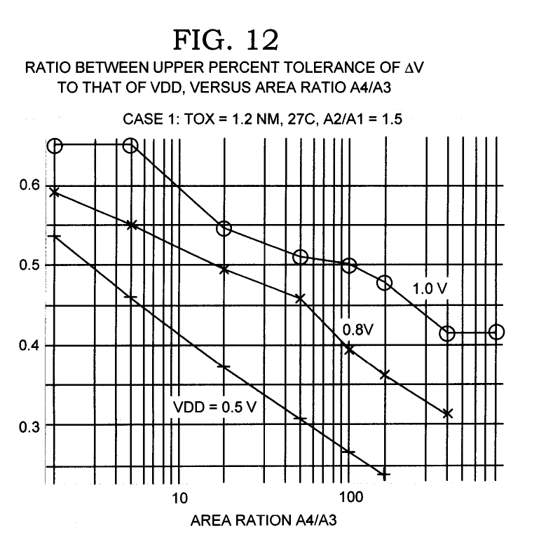

Referring to FIG. 12, a plot of the ratio of upper percent tolerances of ΔV to that of Vdd versus area ratio, X2=A4/A3, for Vdd=0.5, 0.8 and 1.0 is shown. Again, the upper percent tolerance of ΔV is less than the upper percent tolerance of Vdd and the ratio between the two tolerances generally decreases as the ratio, X2=A4/A3 increases. With proper design of the gate areas, a fraction of tolerance on ΔV to the supply voltage Vdd may be obtained. As shown in FIG. 12, the upper percent tolerance of reference voltage ΔV is smaller than the upper percent tolerance of Vdd, and the ratio between the two tolerances generally decreases as the ratio A4/A3 increases. The circuit shown in FIG. 9 is particularly well suited for higher values of the reference voltage, for example, higher values of the ratio X2, which results in even smaller values for the ratio between both the lower and upper percent tolerances on ΔV to Vdd.

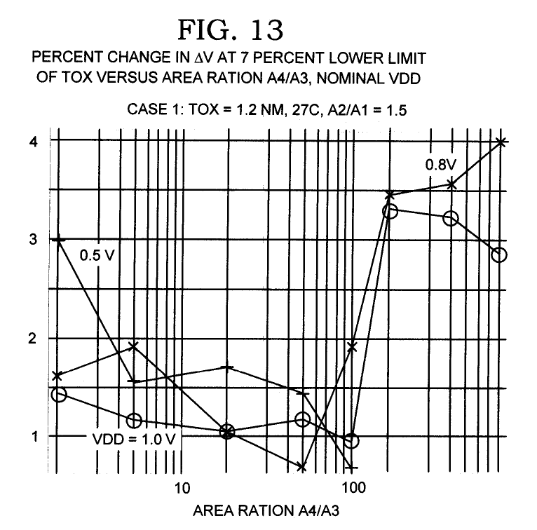

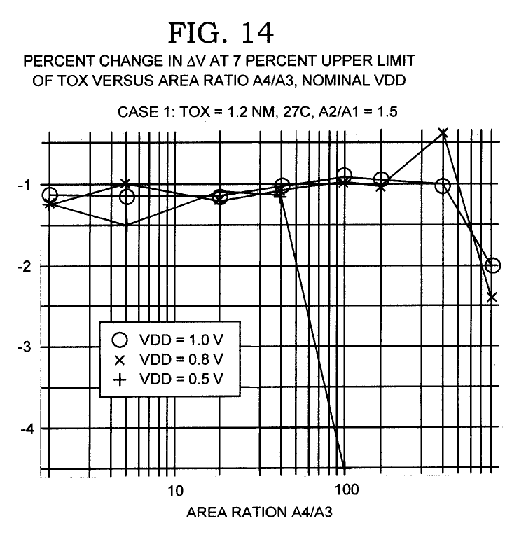

As shown in FIG. 6, the change in ΔV in the temperature range of −55° C. to 125° C. is less than 0.5% in magnitude. Variation of oxide thickness (Tox) between neighboring devices on the same chip is very small, typically much less than 1%. The variations of Tox from wafer to wafer and lot to lot were also considered. In FIG. 13, the percent change in the magnitude of ΔV versus area ratio A4/A3 is plotted for Tox at −7% of its nominal value for case 1. The percent change of ΔV is less than 4% in magnitude for A2/A1=1.5 for a 7% decrease in oxide thickness from a nominal value of 1.2 nm at nominal Vdd. Referring to FIG. 14, the percent change in the magnitude of ΔV versus area ratio A4/A3 is plotted for Tox at +7% of its nominal value. The percent change of ΔV is less than 5% in magnitude for A2/A1=1.5 for a 7% increase in oxide thickness from a nominal value of 1.2 nm at nominal Vdd. Practically speaking, the majority of a given chip population will experience approximately +/−4% variation in Tox, therefore the effect on ΔV would be within about 2% of a nominal magnitude.

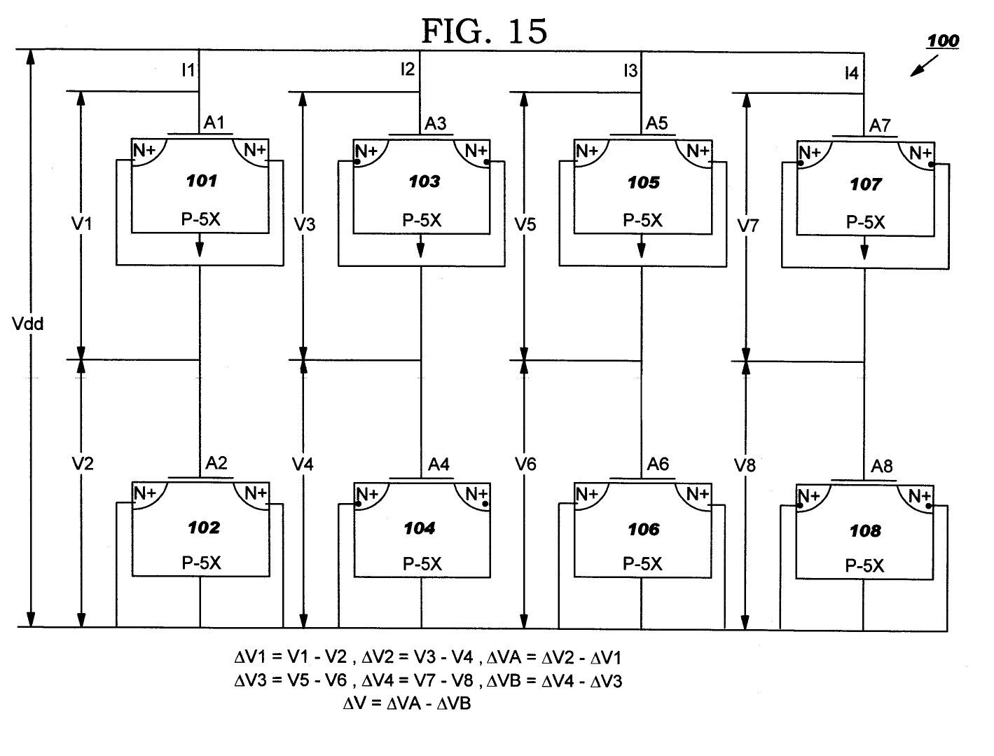

A voltage reference circuit 100 according to a second embodiment of the present invention is illustrated in FIG. 15. (Case 2) To further reduce variation in the reference voltage generator output, the number of parallel paths is doubled, such that four tunneling current paths are realized 11-14. The network of NFET devices is arranged in a configuration of four branches each with two tunneling NFETS 101-108 connected in series to Vdd. The ratio A2/A1=A6/A5=X1=1.5, A8/A7=50, and the area ratio A4/A3=X2 is varied. The NFETS for the first branch have areas A1 and A2 corresponding to node voltages V1 and V2, respectively. The NFETS for the second branch have areas A3 and A4 corresponding to node voltages V3 and V4 respectively. The NFETS for the third branch have areas A5 and A6 corresponding to node voltages V5 and V6. The NFETS for the fourth branch have areas A7 and A8 corresponding to node voltages V7 and V8 respectively. The output reference voltage for case 2 is derived as follows:

$$Δ V 1 = V 1 - V 2 \\ Δ V 2 = V 3 - V 4 \\ Δ V A = Δ V 2 - Δ V 1 \\ Δ V 3 = V 5 - V6 \\ Δ V 4 = V 7 - V8 \\ Δ VB = Δ V 4 - Δ V 3 \\ \begin{matrix}Δ V = Δ V A - Δ VB \\ = [ 2 * ( V 2 - V 4 ) ] + [ 2 * ( V 8 - V 6 ) ]\end{matrix} \qquad ( 6 )$$

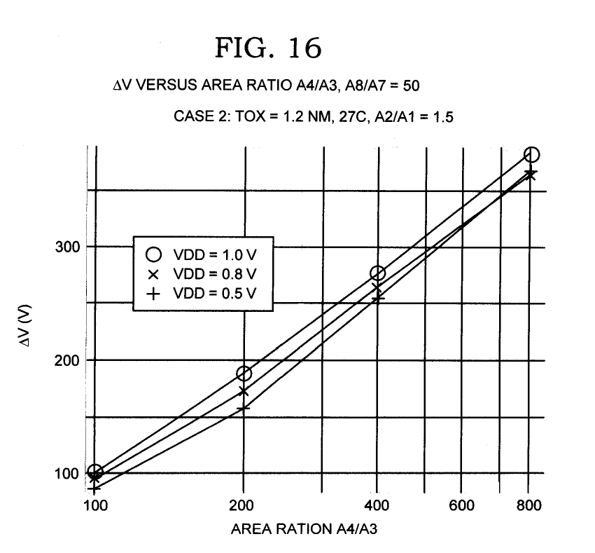

FIG. 16 shows the output reference voltage ΔV versus the area ratio (A4/A3)=X2 according to the second embodiment (Case 2) for Vdd values of 0.5, 0.8 and 1.0 volts, respectively. The graph is directed to an oxide thickness of 1.2 nm at 27° C. and area ratios A2/A1=1.5 and A8/A7=50. The circuit configuration according to the second embodiment is suitable for a lower range of values for ΔV as compared to the first embodiment.

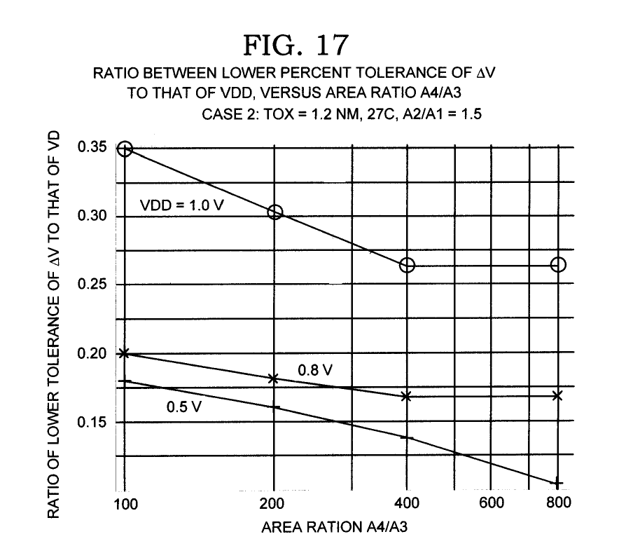

FIG. 17 shows the ratio of the lower percent tolerance of reference voltage ΔV to the lower percent tolerance of Vdd versus area ratio A4/A3, according to the second embodiment, for Vdd=0.5, 0.8 and 1.0 volts, respectively. The tolerances are plotted for an oxide thickness of 1.2 nm at 27° C. and area ratios A2/A1=1.5 and A8/A7=50. Under these conditions, the lower percent tolerance of the output reference voltage ΔV is less than the lower percent tolerance for Vdd and the ratio between the two tolerances is smaller for lower values of the output reference voltage, which is beneficial for low voltage applications. Comparing FIG. 17 with FIG. 11 for Case 1, it is apparent that the lower percent tolerance of ΔV can be made smaller for Case 2. However, Case 2 requires approximately twice the area of Case 1 to implement.

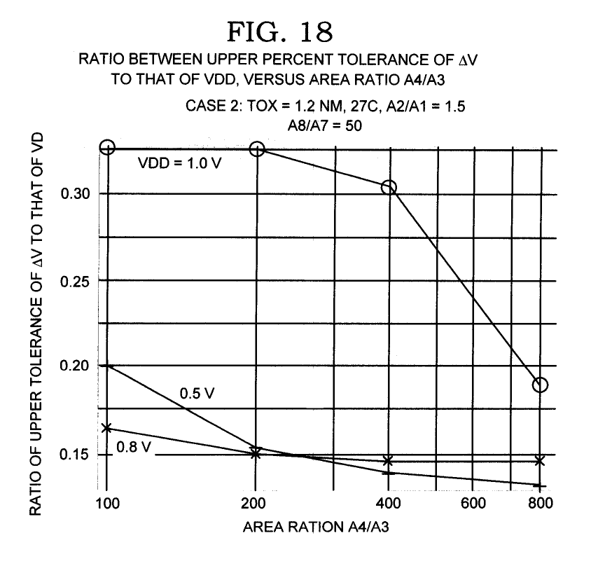

The upper percent tolerances of reference voltage ΔV to that of Vdd versus area ratio A4/A3, according to the second embodiment, for Vdd=0.5, 0.8 and 1.0 volts, respectively, are plotted in FIG. 18. The tolerances are plotted for an oxide thickness of 1.2 nm at 27° C. and area ratios A2/A1=1.5 and A8/A7=50. Under these conditions, the upper percent tolerance of the output reference voltage ΔV is less than the upper percent tolerance for Vdd and the ratio between the two tolerances is smaller for lower values of the output reference voltage, which is beneficial for low voltage applications. From these results, it is clear that Case 2 is better suited than Case 1 for lower values of the output reference voltage where lower ratios of the tolerance on ΔV to that of Vdd can be obtained. Comparing FIG. 18 with FIG. 12 for Case 1 it is apparent that the upper percent tolerance for ΔV can be made smaller for Case 2, however, the area penalty associated with Case 2 remains an issue. Again, the change in ΔV in the temperature range of −55° C. to 125° C. is less than 0.5% in magnitude. Similar to the results obtained for Case 1 (FIG. 9), the change in ΔV due to a +/−3% change in Tox for Case 2 (FIG. 15) is within 2% of the total range of variation.

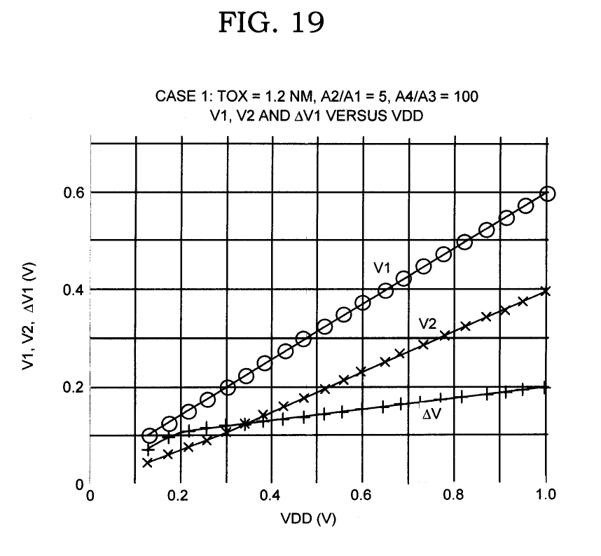

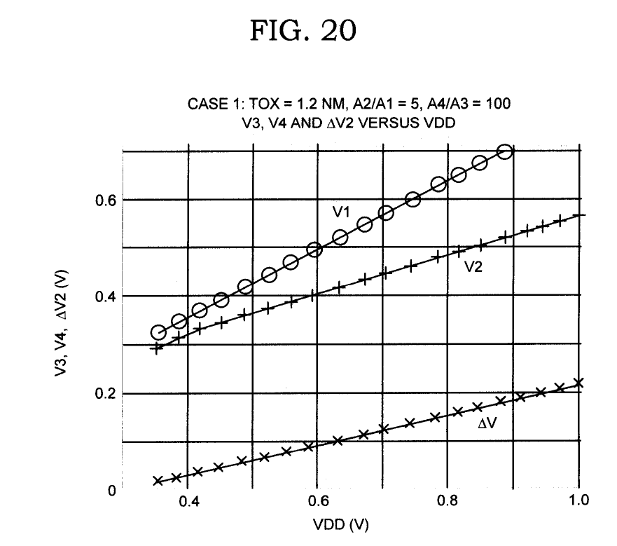

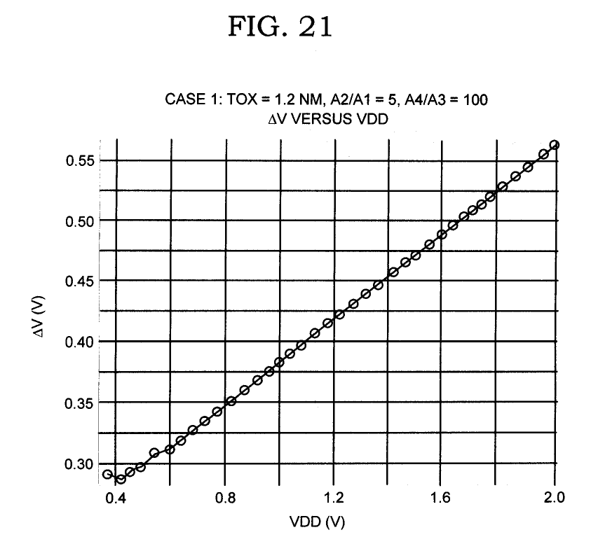

In addition, the voltage reference circuit can be designed such that all the node voltages: V1, V2, V3, V4, are made sufficiently large (i.e.: >100 mV) so that ΔV1, ΔV2 and ΔV can be generated with operational amplifiers. In Case 1, for example, if A2/A1=5, A4/A3=100, and Tox=1.2 nm, FIGS. 19 and 20 show that all the node voltages are greater than 100 mV for Vdd of 0.6 V or higher. (FIG. 19 shows V1, V2, and ΔV1 versus Vdd, and FIG. 20 shows V3, V4, and ΔV2 versus Vdd.) FIG. 21 shows the measured data for the output reference voltage ΔV versus Vdd, for Case 1. The final output voltage reference, ΔV is plotted for an oxide thickness of 1.2 nm at 27° C. and area ratios of A2/A1=5 and A4/A3=100, respectively.

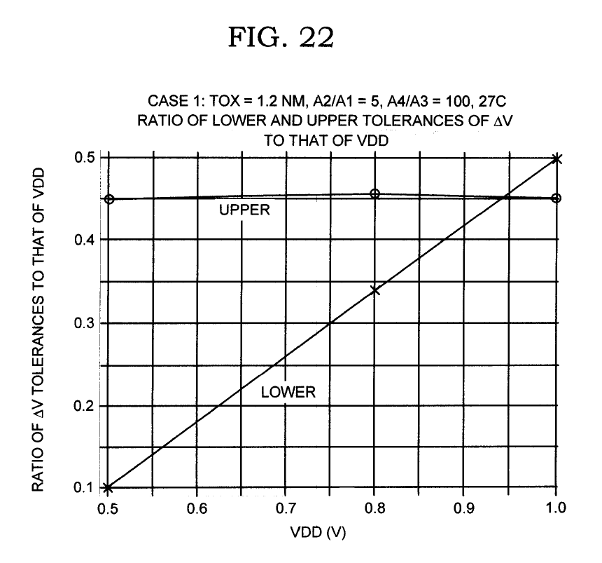

FIG. 22 shows the ratio of the lower and upper tolerances of ΔV to that of Vdd versus Vdd, for Case 1. The tolerances are plotted for an oxide thickness of 1.2 nm at 27° C. and area ratios of A2/A1=5 and A4/A3=100. Under the stated conditions, the upper tolerance ratio remains virtually constant with Vdd while the lower tolerance ratio increases linearly with Vdd. The results further indicate that the percent tolerance in ΔV to that of Vdd for the stated ratios is less than 0.5 in magnitude.

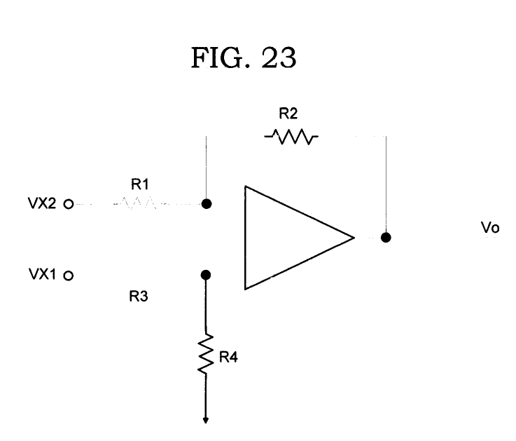

FIG. 23 shows an operational amplifier schematic suitable for calculating the output reference voltage ΔV for Case 1 (i.e., ΔV=[2*(V2−V4)]). In FIG. 23, the ratio R2/R1=R4/R3, and the output voltage is given by:
Vo=(R2/R1)*(VX1−VX2) (7)

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A voltage reference circuit, comprising:
a network of tunneling circuit elements forming a voltage divider, the network adapted to generate a voltage difference derived from a plurality of tunneling currents in the network.

2. The voltage reference circuit according to claim 1, wherein each of the tunneling circuit elements further comprises a tunneling current region.

3. The voltage reference circuit according to claim 1, wherein the network of tunneling circuit elements comprises a voltage divider having a first tunneling current path.

4. The voltage reference circuit according to claim 1, wherein the network of tunneling circuit elements comprises a voltage divider having a first tunneling current path and a second tunneling current path.

5. The voltage reference circuit according to claim 1, wherein the network of tunneling circuit elements comprises a plurality of NFET devices.

6. The voltage reference circuit according to claim 1, wherein the network of tunneling circuit elements comprises a plurality of PFET devices.

7. The voltage reference circuit according to claim 1, wherein the network of tunneling circuit elements comprises a plurality of parallel plate capacitors.

8. The voltage reference circuit according to claim 2, wherein the tunneling current region comprises a dielectric material that is essentially non-conductive.

9. The voltage reference circuit according to claim 8, wherein the tunneling current region comprises a dielectric material implanted with a specified concentration of impurities.

10. The voltage reference circuit according to claim 2, wherein the tunneling current region comprises a gate oxide material that is essentially non-conductive.

11. The voltage reference circuit according to claim 10, wherein the tunneling current region further comprises a tunneling implant region adjacent to the gate oxide material, the tunneling implant region providing a current path between a first node and a second node of the tunneling circuit element.

12. The voltage reference circuit according to claim 4, wherein the first tunneling current path comprises a first MOSFET coupled to a second MOSFET and the second tunneling current path comprises a third MOSFET coupled to a fourth MOSFET.

13. The voltage reference circuit according to claim 4, wherein the voltage divider further comprises a third tunneling current path and a fourth tunneling current path.

14. The voltage reference circuit according to claim 13, wherein the third tunneling current path comprises a fifth MOSFET coupled to a sixth MOSFET and the fourth tunneling current path comprises a seventh MOSFET coupled to an eighth MOSFET.

15. The voltage reference circuit according to claim 12, further comprising:
a first MOSFET having a gate driven by an input current and a source and a drain coupled to a first node;
a second MOSFET having a gate coupled to the first node and a source and a drain coupled to a second node;
a third MOSFET having a gate driven by the input current and a source and a drain coupled to a third node; and
a fourth MOSFET having a gate coupled to the third node and a source and a drain coupled to a fourth node.

16. The voltage reference circuit according to claim 15, wherein the second node and the fourth node are coupled to a common potential.

17. The voltage reference circuit according to claim 15, wherein a gate oxide area of the first MOSFET is less than a gate oxide area of the second MOSFET.

18. The voltage reference circuit according to claim 15, wherein a gate oxide area of the third MOSFET is less than a gate oxide area of the fourth MOSFET.

19. The voltage reference circuit according to claim 15, wherein the third MOSFET has a gate oxide area substantially equal to a gate oxide area of the first MOSFET.

20. The voltage reference circuit according to claim 15, wherein the area ratio of the second MOSFET to the first MOSFET and the area ratio of the fourth MOSFET to the third MOSFET are optimized in accordance with a desired value of the voltage difference.

21. The voltage reference circuit according to claim 1, wherein the voltage difference output of the voltage reference circuit is independent of temperature within a range of about −55 to 125 degrees Celsius.

22. The voltage reference circuit according to claim 1, wherein an output tolerance of the voltage reference circuit is less than an output tolerance for an input power supply voltage driving the voltage reference circuit.

23. A method of generating a voltage reference, the method comprising:
providing a first MOSFET having a gate terminal driven by an input current and a source and a drain coupled to a first node;
providing a second MOSFET having a gate terminal coupled to the first node and a source and drain coupled to a second node;
providing a third MOSFET having a gate terminal driven by the input current and a source and a drain coupled to a third node;
providing a fourth MOSFET having a gate terminal coupled to the third node and a source and a drain coupled to a fourth node;
determining a first voltage between the second node and the first node;
determining a second voltage between the fourth node and the third node; and
generating a voltage reference corresponding to a difference between the first voltage and the second voltage.

24. The method according to claim 23, wherein the voltage reference is derived from a gate oxide tunneling current in each of the first, second, third and fourth MOSFETs.

25. The method according to claim 23, wherein a gate oxide area of the second MOSFET is greater than a gate oxide area of the first MOSFET.

26. The method according to claim 23, wherein a gate oxide area of the fourth MOSFET is greater than a gate oxide area of the third MOSFET.

27. The method according to claim 23, wherein the third MOSFET has a gate oxide area substantially equal to a first gate oxide area of the first MOSFET.

28. The method according to claim 23, wherein the area ratio of the second MOSFET to the first MOSFET and the area ratio of the fourth MOSFET to the third MOSFET are each optimized in accordance with a desired value of the voltage difference.

29. The method according to claim 24, further comprising:
defining a slope parameter used to derive an expression for the gate oxide tunneling current as a linear function on a logarithmic scale of a gate voltage.

30. The method according to claim 24, further comprising:
defining the magnitude of an intercept parameter used to derive an expression for the gate tunneling current on a logarithmic scale as a linear function of the gate voltage.

31. The method according to claim 23 further comprising:
specifying an output tolerance for the voltage reference circuit of up to about 25 percent of a power supply voltage tolerance.

32. A method of generating a voltage reference, the method comprising:
implementing a voltage divider having a network of tunneling circuit elements; and
calculating a voltage difference derived from a plurality of tunneling currents in the network.

33. The method according to claim 32, wherein the MOSFET network comprises a plurality of NFET devices.

34. The method according to claim 32, wherein a gate oxide thickness of each of the plurality of NFET devices varies within a range of about 0.8 nm to about 4.0 nm.

35. The method according to claim 32, wherein the MOSFET network of tunneling current elements comprises a voltage divider having a first tunneling current path and a second tunneling current path.

36. The method according to claim 32, wherein the voltage difference output of the voltage reference circuit is independent of temperature within a range of about −55 to 125 degrees Celsius.

37. The method according to claim 32 further comprising:
specifying an output tolerance for the voltage reference circuit of up to about 25 percent of a power supply voltage tolerance.

38. A program storage device readable by a machine, tangibly embodying a program of instructions executable by the machine to perform method steps for implementing a voltage reference circuit, said method steps comprising:
providing a first NFET having a gate terminal driven by an input current and a source and a drain coupled to a first node;
providing a second NFET having a gate terminal coupled to the first node and a source and drain coupled to a second node;
providing a third NFET having a gate terminal driven by the input current and a source and a drain coupled to a third node;
providing a fourth NFET having a gate terminal coupled to the third node and a source and a drain coupled to a fourth node;
determining a first voltage between the second node and the first node;
determining a second voltage between the fourth node and the third node; and
generating a voltage reference corresponding to a difference between the first voltage and the second voltage.
